(19) United States
(12) Patent Application Publication
(10) Pub. No.: US 2004/0267674 A1
(43) Pub. Date: Dec. 30, 2004

(54) Method for complex computer aided pricing of products and services

(76) Inventors: Yan Feng, Los Altos, CA (US); Nandhakumar Palanisamy, San Jose, CA (US); Sanjay Mittal, Fremont, CA (US); Shriniwas Ramkrishna Gadage, Pune (IN); Mangal Sain, New Delhi (IN); Prem Malhotra, Cupertino, CA (US); Karen Hsu, Hayward, CA (US); Reuben Swartz, Austin, TX (US)

Correspondence Address: CENTRAL COAST PATENT AGENCY, PO BOX 187, AROMAS, CA, 95004, US

(21) Appl. No.: 10/611,471

(22) Filed: Jun. 30, 2003

(51) Int. Cl. G06F 17/60

(52) U.S. Cl. 705/400; 705/10

(57) ABSTRACT

An automated pricing system for calculating pricing for items and item orders has, a sever node connected to a data network for serving pricing information; a pricing application running on the server node for calculating the pricing information served; and a data repository accessible to the server node for storing at least one pricing data model and rules for manipulating the model. The server node receives requests for pricing, accesses rules created for pricing factors used in at least one pricing sequence to price an item or items of the request and uses the pricing application to calculate the correct pricing results including order sub totals and order total amounts for the request based on sorting and/or conflict resolution of the rules accessed for each factor.

### FIELD OF THE INVENTION

The present invention is in the field of computer-assisted pricing of goods and services and pertains particularly to improved methods and apparatus for figuring pricing based on price sequence calculation per item and order attributes.

### Background of the Invention

The field of computer-aided pricing generally involves inputting a number of variables into a database and then retrieving those variables to apply in one or more pricing schemes provided as calculative sequences, to eventually arrive at a final price for a product or service offered to particular clients of an enterprise. Computer-aided pricing applications have largely replaced human-calculated pricing as a preferred method for establishing current pricing for clients of larger enterprises that offer a variety of products and/or services to a variety of client types.

The need for computerizing pricing sequences has long been established as a preferred method, especially for larger enterprises. Pricing discounts of various sorts, rebates, volume purchasing, contract agreements, special price rollbacks, interest, tax rates, currency conversions, bundled products and the like comprise many of the complexities associated with creative pricing in today's business environment.

With the advent of broad-based client accessibility to self-service portals, typically provided through wide-area-networks like the well-known Internet, pricing systems have been the enabling factor for survival of many organizations. Without these systems in place, many of these organizations would lose considerable time and resources attempting to provide all of their pricing structures in an accurate and timely manner.

While there are pricing systems in the prior art that provide some automated pricing calculation for specific clients, the space required to store data tables containing all of the required factors and variables is exorbitant. Likewise, the time required to access the various tables of data in order to retrieve the “correct” tables for processing pricing for a particular client, while faster and more accurate than human effort, is still very time consuming and process intensive.

The inventor knows of a prior-art system that relieves some of the burden of data storage and data lookup processes by providing a hierarchal tree-method for calculating a correct pricing for a specific client or purchasing organization. This prior-art system is referenced herein as U.S. Pat. No. 5,878,400 issued on Mar. 2, 1999 to Thomas J. Carter; III, hereinafter referred to simply as Carter.

The system of Carter organizes various pricing tables and price adjustment tables for various products and purchasing entities based on which purchasing entity is purchasing which specific product. The invention utilizes de-normalized numbers in tables to relate the requesting purchaser to the product desired. The different types of purchasers and the various types of products offered are organized into hierarchical groups represented by data tables. Working by individual hierarchical levels, of which there may be many, specific price adjustments can be specified for each created level of the organizational groups and for each created level of the product groups.

The system determines final pricing for a purchasing entity and product desired by retrieving the listed price adjustments for that particular purchasing entity as well as all of the listed price adjustments for the listed groups above the particular purchasing entity in the groups hierarchy. Likewise, the price adjustments for a particular listed product are determined by retrieving the price adjustments for that listed particular product as well as the price adjustments for all of the product groups listed above the particular product in the product-group hierarchy.

The system then must sort through all of the retrieved pricing information to isolate the particular pricing adjustments that fit the selected purchaser and product. The final pricing adjustments aggregated are then applied in the form of a pricing sequence to arrive at a final price at which a particular product can be sold to a particular purchasing entity.

While the system does limit the need for much duplication of data over multiple product and purchaser-specific data tables, it still requires much processing in order to drill down the hierarchal price-adjustment structure until the pricing adjustments that match the given scenario are finally identified and isolated to use in calculating the final pricing. An enterprise with a large number of different products, client types, and pricing strategies would find the system of Carter quite process-intensive. Furthermore, the system of Carter fails to provide a solution for creative pricing strategies such as tiered pricing, product or service bundling, or other creative pricing structures.

With the advent of object orientation, including model representation of real data, it has occurred to the inventors that far more complex pricing strategies for varied clients can be applied in a much less process-intensive manner than in the prior-art systems. Therefore, what is clearly needed is a method and apparatus that can produce correct and accurate pricing presentations for purchase orders and general pricing sheets, lists, and reports using complex strategies in a timely manner agreeable to real-time order processing. A system such as this would be less process intensive, take less overall time processing orders and could also provide the enterprise with order, or product-specific profit margin reports, client segregated profit-margin reports, and profit reporting averaged over large sectors of differing products, services, and client types.

### SUMMARY OF THE INVENTION

In a preferred embodiment of the present invention an automated pricing system for calculating pricing for items and item orders is provided, comprising a server node connected to a data network for serving pricing information, a pricing application running on the server node for calculating the pricing information served, and a data repository accessible to the server node for storing at least one pricing data model and rules for manipulating the model. The pricing system characterized in that the server node receives requests for pricing, accesses rules created for pricing factors used in at least one pricing sequence to price an item or items of the request and uses the pricing application to calculate the correct pricing results including sub totals and total amounts for the request based on sorting and/or conflict resolution of the rules accessed for each factor.

In some preferred embodiments the data network is the Internet network. In some other preferred embodiments the data network is a local area network connected to the Internet network. In still others pricing requests are received from a business-to-business server connected to the data network the requests generated in an automated fashion and routed to and queued in the pricing server for processing. In yet other embodiments pricing requests are received from clients accessing an enterprise hosted Web server connected to the data network, the requests routed to and queued in the pricing server for processing.

In some other the requests are received from a client operating from a wireless network-capable device through a wireless interface having connection to the data network, the requests routed to and queued in the pricing server for processing. In yet other embodiments the pricing requests are received from a third-party price configuration application running on a node connected to the data network, and in others the served pricing information is item pricing generated in the form of a pricing list.

In some cases the pricing information includes indication of profit margin for each item and for the order, and in some cases there are multiple pricing models applicable to different pricing methods. Also in some cases the methods include product-based pricing, product scope pricing, contract pricing, tiered pricing, and bundled pricing. In still other cases there is one pricing model extensible to reflect multiple pricing methods. In yet other cases the methods include product-based pricing, product scope pricing, contract pricing, tiered pricing, and bundled pricing.

In further embodiments of the invention the repository is part of a legacy system, and in yet further embodiments pricing rules are accessed, sorted and resolved for conflict in sequence for each listed factor having rules in the order that each factor exists in the at least one pricing sequence staring with the first factor in the first sequence.

In another aspect of the invention a software application suite for calculating prices for pricing requests received by the application is provided, comprising a pricing server component for calculating pricing based on pricing factors used in at least one pricing sequence, a pricing management application for creating at least one pricing model and for updating and editing the at least one model, a model validation component for testing the integrity of the at least one pricing model, a pricing list generator for generating line item pricing lists, and at least one application program interface for enabling third-party applications of varying platforms to communicate with the pricing server component. The suite is characterized in that pricing requests received are handled in automated fashion for one or a combination of product-based pricing, product scope pricing, contract pricing, tiered pricing, and bundled pricing scenarios by matching rule constraints to request parameters for each pricing factor in a given pricing sequence used by the application to calculate pricing for a given request.

In some preferred embodiments pricing requests are received from a business-to-business server having data-network-access to the application suite, the requests generated in an automated fashion and routed to and queued in a machine hosting the server component of the application. In others the pricing requests are received from clients having data-network-access to an enterprise hosted Web server connected to the data network, the requests routed to and queued in a machine hosting the server component of the application. In still others the requests are received from a client operating from a wireless network-capable device through a wireless interface having access to the application, the requests routed to and queued in a machine hosting the server component of the application. In yet other embodiments the pricing requests are received from a third-party price configuration application running on a node having access to the application, the requests routed to and queued into a machine hosting the server component of the application.

In some cases the pricing information includes indication of profit margin for each item and for the order, and in some other cases there are multiple pricing models applicable to different pricing methods. In still other cases the third-party applications use the at least one API for translating platform dependent markup languages to enable cross communication between a client platform and the platform hosting the software application. In yet other cases client platforms capable of cross-communication with the software application include CTI telephony platforms including Interactive Voice Response systems, platforms using Wireless Markup Language, Voice over Internet Protocol, Hypertext Markup Language, and Extensible Markup Language.

In another aspect of the invention an automated pricing system for calculating pricing for items and item orders, the system including a pricing application running on a server node, and a data repository accessible to the server node for storing at least one pricing data model and rules for manipulating the model, a method for price calculation of an item in the pricing request is provided, comprising steps of (a) receiving the pricing request for processing; (b) identifying an item pricing sequence comprising pricing factors used in calculating; (c) accessing the rules for the first listed factor in the sequence having associated rules; (d) sorting the rules based on constraint matching to parameters in the request; (e) eliminating those rules that do not match the request parameters; (f) applying the value of the remaining rule that most closely matches the request parameters to the factor; (g) repeating steps (c) through (f) for each factor in the sequence that has associated rules; and (h) calculating the price of the item using the values assigned to the factors of the sequence.

In some preferred embodiments in step (a) the request has more than one item listed for pricing and the method is repeated for each item in the request using the same pricing sequence. In some other embodiments in step (b) the pricing sequence is an item pricing sequence selected by default according to a pricing model. In yet other embodiments in step (c) the rules are accessed from a data repository containing the pricing model data. In some other cases in step (c) the rules for the factor specify necessarily, the item being processed, a customer requesting the item pricing, and the sequence factor associated with the rule, and optionally, an item category associated with the item, an effective date of the rule, an expiry date of the rule, and the minimum and maximum quantity ranges of the item ordered.

In yet other embodiments of this method in step (d) the parameters in the request specify necessarily, a request date, a customer that initiated the request, the item being processed, and the sequence used to calculate the pricing, and optionally, a contract date, a sales channel, and attributes assigned to the customer, item, and channel. In still other embodiments an additional step is required between steps (e) and (f) for conflict resolution in case of more than one candidate rule remaining after step (e).

In still another aspect of the invention, in an automated pricing system for calculating pricing for items and item orders, the system including a pricing application running on a server node, and a data repository accessible to the server node for storing at least one pricing data model and rules for manipulating the model, a method for price calculation of the total figure of multiple items in the pricing request is provided, comprising steps of (a) after items have been individually priced using a pricing sequence, identifying an order pricing sequence comprising factors used in calculating totals; (b) accessing rules for the first listed factor in the sequence having associated rules; (c) sorting the rules based on constraint matching to parameters in the request; (d) eliminating those rules that do not match the request parameters; (e) applying the value of the remaining rule that most closely matches the factor; (f) repeating steps (b) through (e) for each factor in the sequence that has associated rules; and (g) calculating the order totals for the order using the values assigned to the factors of the sequence.

In some embodiments of this method in step (a) the order pricing sequence is selected by default according to the pricing model. In other embodiments in step (b) the rules are accessed from a data repository containing the pricing model data. In other embodiments in step (g) the order totals reflect one or a combination of a bundle discount, a group discount, and a volume discount. In yet other embodiments an additional step is required between steps (d) and (e) for conflict resolution in case of more than one candidate rule remaining after step (c).

In some cases the conflict resolution step resolves rule conflicts according to a specified conflict resolution order specified in the factor being processed, while in other cases the conflict resolution step resolves rule conflicts according to a specified resolution order specified in the factor being processed.

BRIEF DESCRIPTION OF THE DRAWING FIGURES

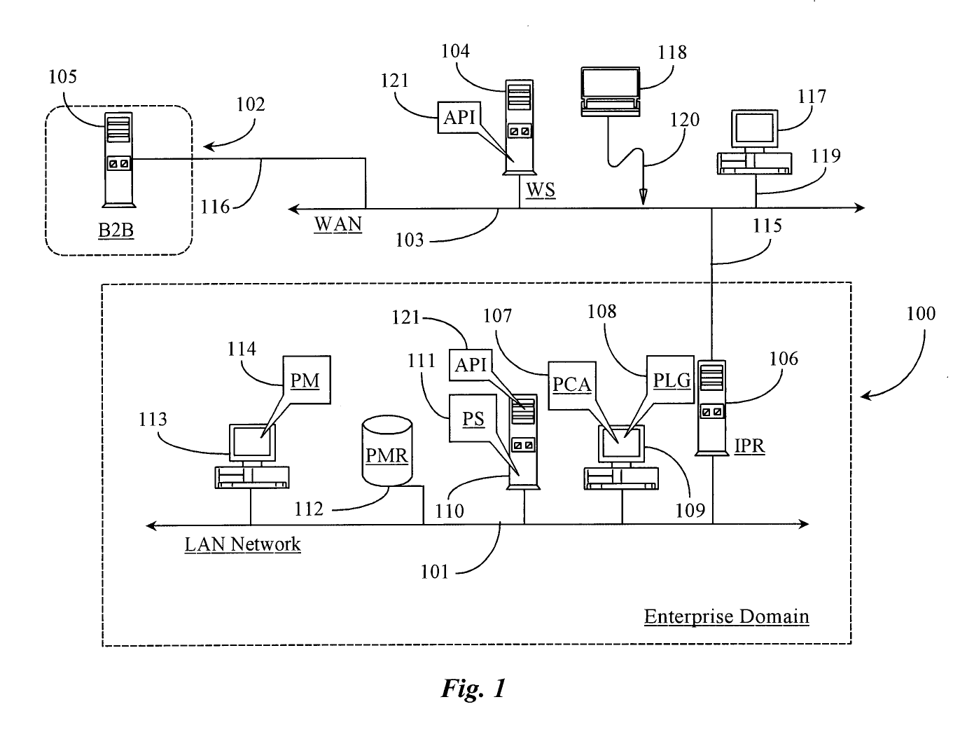

FIG. 1 is an architectural over view of the pricing system of the present invention.

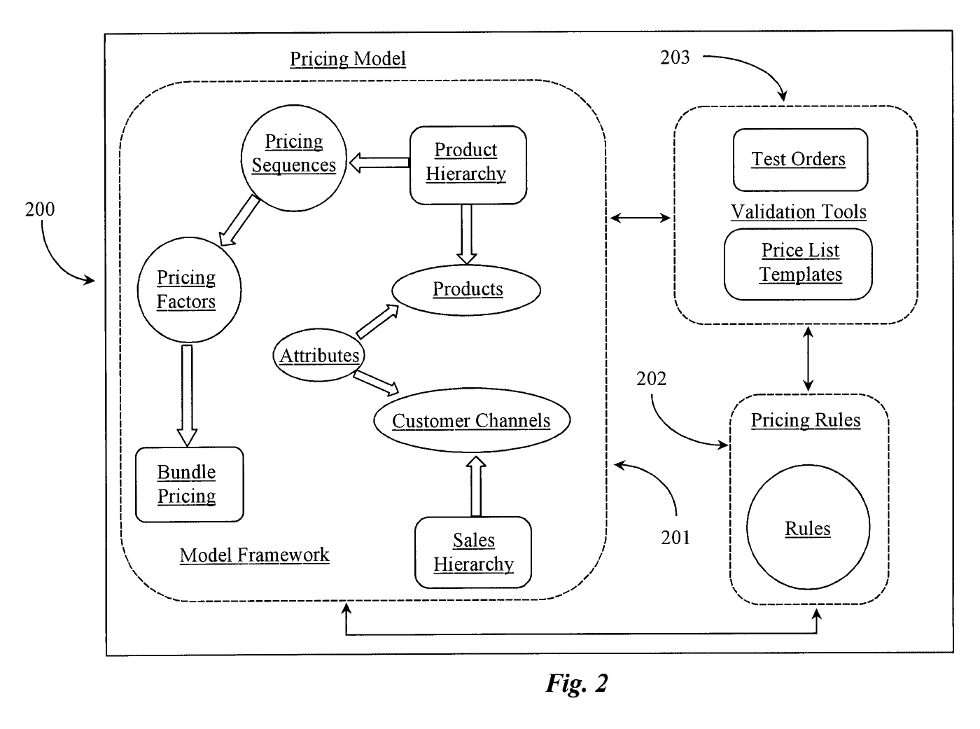

FIG. 2 is a block diagram illustrating a pricing model according to an embodiment of the present invention.

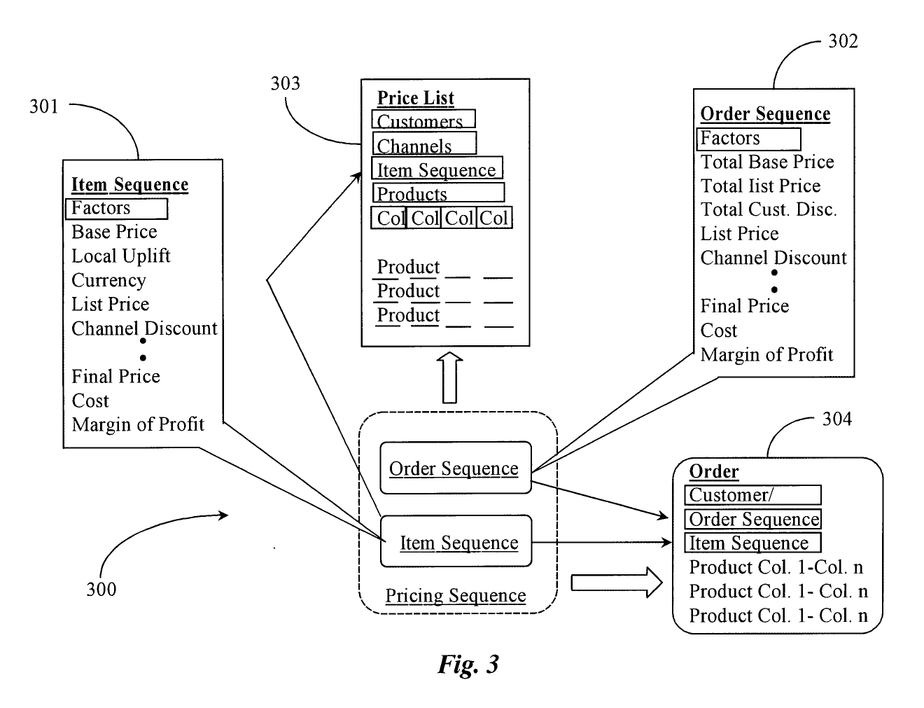

FIG. 3 is a block diagram illustrating the function of price sequencing according to an embodiment of the present invention.

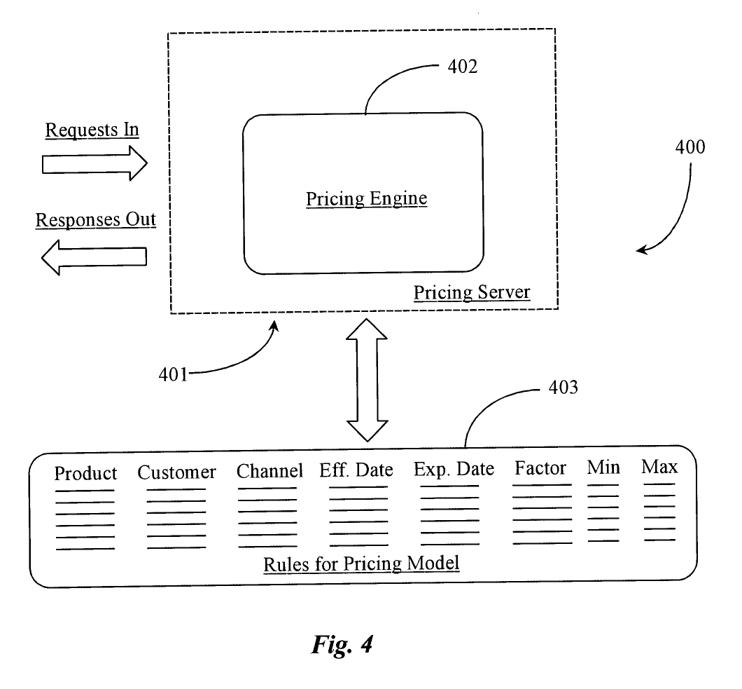

FIG. 4 is a block diagram illustrating relationship between the pricing engine and a rules base according to an embodiment of the present invention.

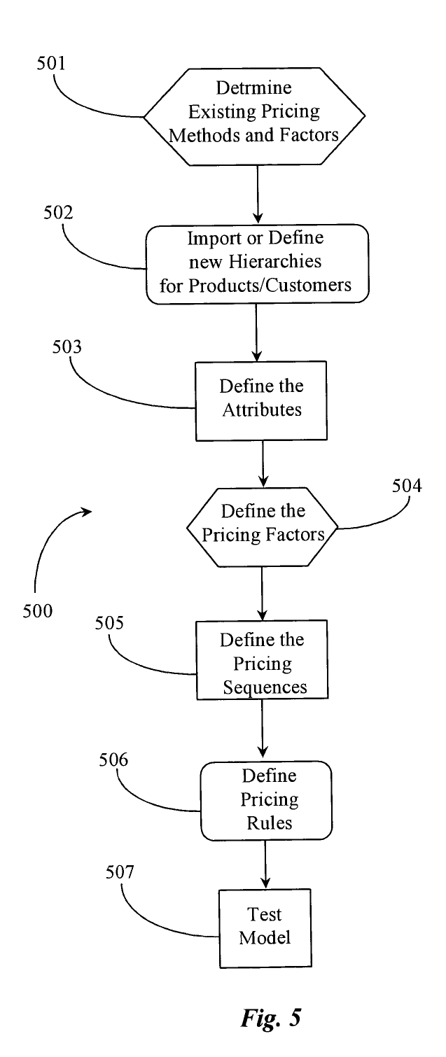

FIG. 5 is a process flow chart illustrating steps for building a pricing model according to an embodiment of the present invention.

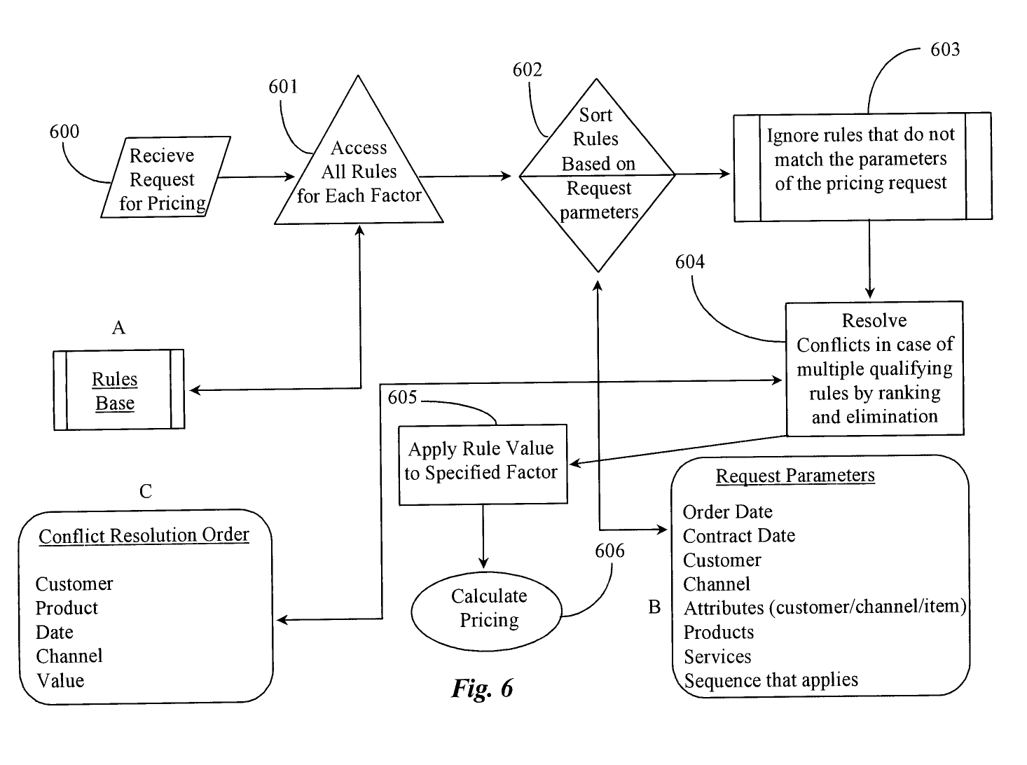

FIG. 6 is a process flow chart illustrating steps for applying rules to factors before calculating prices according to an embodiment of the invention.

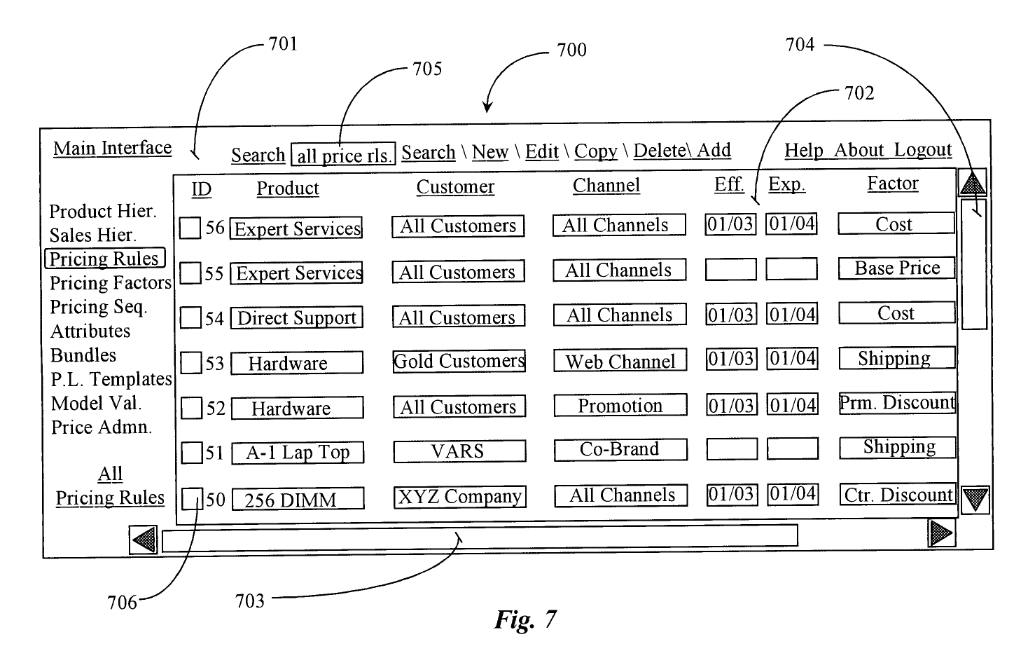

FIG. 7 is an elevation view of a main user-interface screen for practicing the present invention.

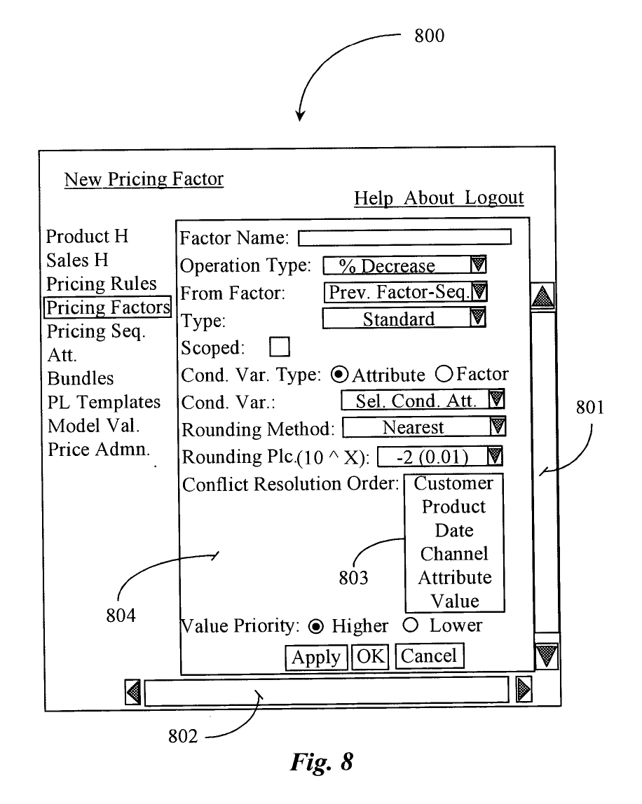

FIG. 8 is an elevation view of a sub-interface for creating a new factor according to an embodiment of the present invention invoked from the main interface of FIG. 7.

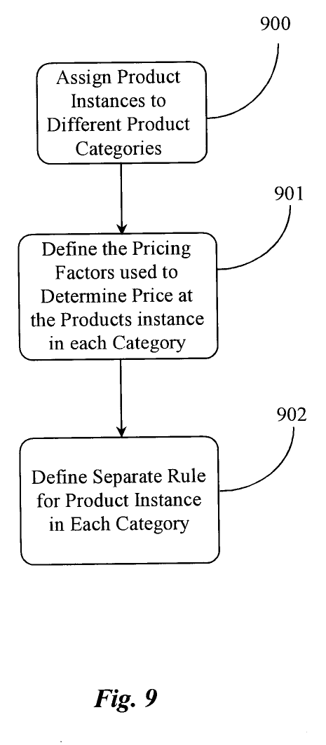

FIG. 9 is a process flow diagram illustrating basic steps for setting up scope pricing according to an embodiment of the present invention.

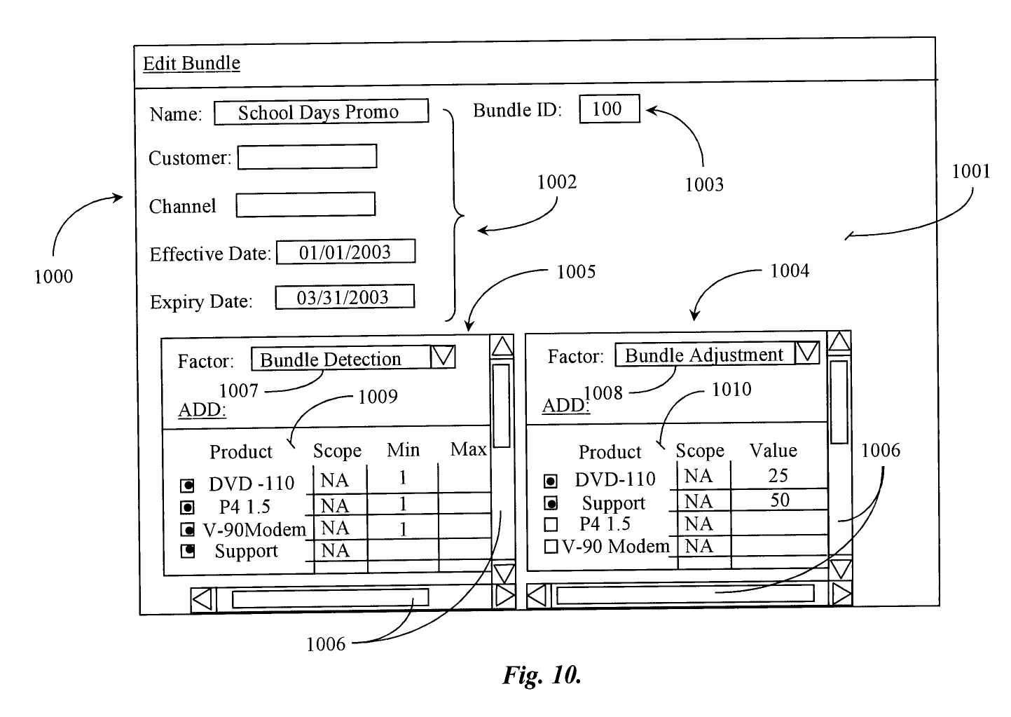

FIG. 10 is a screen shot of a bundle creation and editing interface accessible through main interface 700 of FIG. 7.

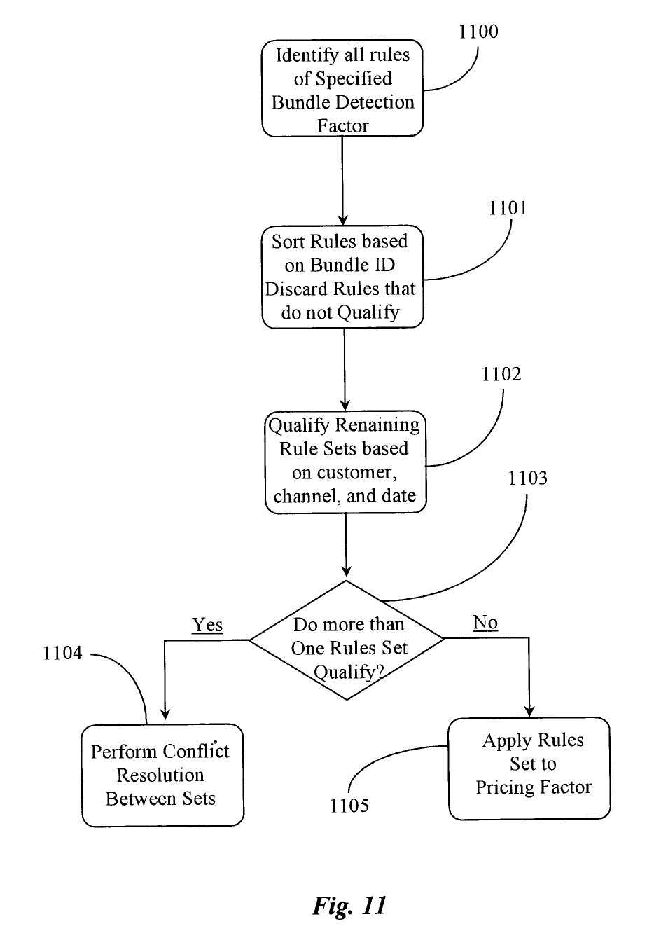

FIG. 11 is a process flow chart illustrating steps for qualifying bundle detection rules for a bundle detection factor.

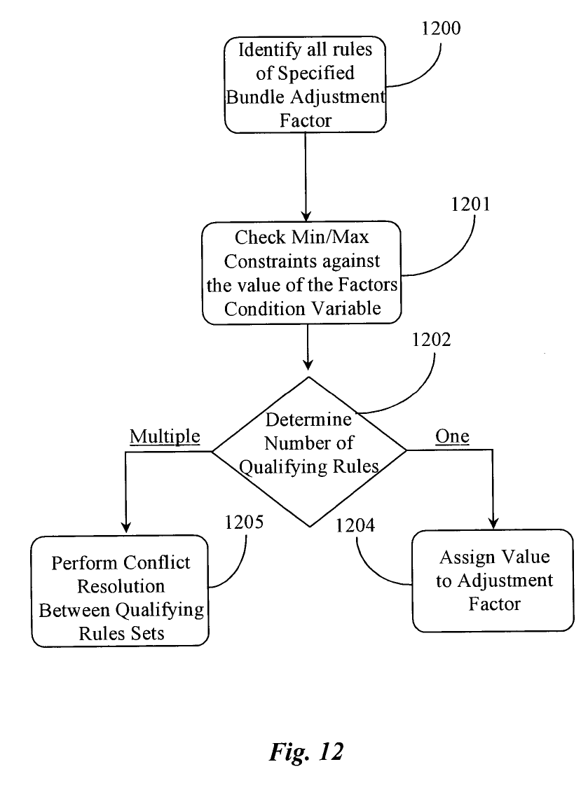

FIG. 12 is a process flow chart illustrating steps for qualifying bundle adjustment rules for a bundle adjustment factor.

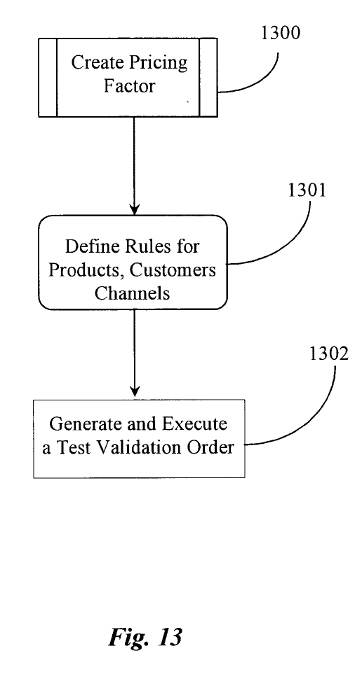

FIG. 13 is a process flow diagram illustrating basic steps for setting up a tiered pricing scenario.

### DESCRIPTION OF THE PREFERRED EMBODIMENTS

The inventors provide an improved system for automatically configuring complex pricing scenarios for enterprise-offered products and services. The methods and apparatus of the invention are described in enabling detail below.

FIG. 1 is an architectural overview of the pricing system of the present invention. An enterprise domain, illustrated herein as domain 100 is illustrated in this example as the host of the pricing system of the present invention. Domain 100 also referred to in this specification, as enterprise 100, can be any type of enterprise that engages in the selling of products and/or services to clients. In this case clients refer to any entity, be it a business or private consumer that might purchase a product or service from enterprise 100.

Enterprise 100 can be implemented physically as a business having a contact or communication center and/or department for sales and general management. Enterprise 100, in this example, has a local-area-network (LAN) 101 provided therein and adapted for transfer control protocol/Internet protocol (TCP/IP) and any other required protocols to enable LAN 101 to serve as a corporate, public, or private wide-area-network (WAN), illustrated in this example as a WAN 103. WAN 103 may be a sub-network to the well-known Internet network, or considered to be the Internet network as a whole.

LAN 101 of enterprise 100 has an Internet protocol-capable data router (IPR) 106 connected thereto and adapted to provide routing services between the physical domain of enterprise 100 and any external client-access points implemented on WAN 103. IPR 106 has access to WAN 103 by way of a network access line 115. A server node 110 is provided within domain 100 and is connected to LAN 101. Server 110 is enabled for practice of the present invention by a pricing server (PS) application 111. PS 111 is the main computational component of the software of the present invention and serves pricing results according to requests made internally accessing via LAN 101 and externally via WAN 103, network line 115 and LAN 101. Pricing server is adapted in a preferred embodiment to perform run-time transaction-type processing.

A desktop node 113 is provided within enterprise 100 and is connected to LAN 101. Node 113 has a pricing management (PM) application 114 provided therein as an executable software application. PM 114 is adapted to enable an administrator operating from node 113 to manage various aspects of a pricing model provided to represent the model of an enterprise pricing structure. PM 114 running on node 113 enables an administrator to manage pricing rules, pricing framework, product and service categories, and client categories.

A second desktop node 109 is provided within enterprise 100 and is connected to LAN 101. Node 109 has a pricing configuration application (PCA) 107 provided therein as an executable application. Pricing configuration application 107 logically represents any enterprise front-end applications that require pricing information to be complete. Node 109 also has a price-list generator (PLG) 108 provided therein as an executable application that enables an administrator operating from node 109, or an automated system application to generate on-demand price lists and pricing reports for products and/or services. It is important to note herein that the software of the present invention does not have to be implemented in distributed portions on more than one server or node in order to practice the present invention. The inventor illustrates a distributed implementation in order to logically separate functions of application modules only. For example, PLG 108 and PM 114 may reside on a single machine. All of the so-far mentioned software components may, in fact, reside on a single machine. PCA applications 107 may be resident applications used internally or third-party applications used by clients to access pricing information from external nodes such as WAN based severs or remote desktop systems.

A data repository 112 is provided within enterprise 100 and is connected to LAN 101. Repository 112 is adapted to store at least one pricing model used by the enterprise and all of the associated data related to the model. Component PM 114 is used to create and update at least one pricing model stored in repository 112. PS 111 responds to client requests for pricing information and accesses one or more pricing models from repository 112 in order to obtain the parameters and variables that enable the server to calculate the correct pricing results according to implemented rule and send a response containing requested pricing information back to the requester entity.

WAN 103, which may be the well-known Internet network, has a business-to-business (B2B) communication server 105 connected thereto by way of a network access line 116. B2B server 105 logically represents a business server maintained by any business domain illustrated herein as a rectangular block labeled with the element number 102. Server 105 is adapted to communicate with pricing server 110 within domain 100 in an automated fashion in order to initiate and complete transactions between business entities, one of which is enterprise 100 in this example.

Server 110 has an application program interface (API) 121 provided thereto as part of server software 111. API 121 is, in a preferred embodiment, Java-enabled to translate business and pricing information between various markup languages that may be used by requesting applications to request pricing information. API 121 can be a single API or a set of APIs depending on the requirements of the system. The system of the present invention is not limited by platform or operating system type and is adapted to translate a wide variety of Web-based and network-based markup languages like Hypertext Markup Language (HTML) based, Extensible Markup Language (XML) based, Wireless-Markup Language (WML) based, and other commonly used languages. The communication ability of the system of the present invention to other platforms and languages includes telephony-based languages like Computer-Telephony-Integration (CTI) based including interaction ability with Interactive-Voice-Response (IVR) systems, Voice over Internet Protocol (VOIP) systems and other voice-enabled automated systems. In this way business clients and independent enterprise customers can access real-time pricing information for virtually any type of order or purchase requirements through a variety of interfacing systems.

WAN 103 has a Web server 104 connected thereto and adapted as a client-access point to services provided by enterprise 100 and is thus assumed to be enterprise hosted. Clients access services offered by enterprise 100 through Web server 104. Web server 104 like server 110, has one or more APIs 121 provided for the purpose of interfacing between various client applications and PS 111. Client access to server 104 is logically represented herein by a client node 117 and a client node 118 connected to WAN 103. Client node 117 represents a client that has access to server 104 through a traditional wired Internet connection brokered by an Internet service provider (ISP) as is generally known in the art. Client node 118 represents a client that has access to server 104 through any wireless service provider from a Laptop computer or another network-capable device. Client node 118 makes access by way of a wireless link 120 and client node 117 makes access by way of a network connection 119. In a preferred embodiment, clients of type 102, 118, and 117 may connect on-line and access real time pricing information through WS 104 (clients 118, 117) or directly through server 105 (client 102) from pricing server 111. Upon receiving a request for pricing, server 111 accesses one or more pricing models from repository 112 according to request parameters and calculates the correct pricing including special discounts, contract prices, and the like according to prevailing enterprise rules. Server 111 sends a response with correct pricing back to the requesting client.

In one embodiment of the present invention PS 111 is Web-based and distributed to a Web-server like server 104 for access by clients 118, 117, and 105. Moreover, clients may be provided with a client application or browser-plug-in that communicates with PS software when requesting pricing information. A goal of the present invention is to provide a more-flexible pricing engine that can produce complex pricing information faster using less computational resources and storage space than prior-art pricing systems.

FIG. 2 is a block diagram illustrating a pricing model 200 according to an embodiment of the present invention. Pricing model 200 is a data model that follows a model framework illustrated herein as model framework 201 (enclosed by dotted rectangle) and is executable according to specific rules that are related to specific pricing scenarios. Model 200 can import pricing attributes and rules from existing enterprise models and can be updated and configured using newly defined attributes and information. Model framework 201 of model 200 includes a product hierarchy structure and a sales hierarchy structure illustrated herein by appropriately labeled blocks.

A sales hierarchy defines the structure and groupings of customer types and channel categories. Channels are the client-grouping vehicles and customers or clients are assigned to specific channels. Channels, more particularly define clients by categories. For example, a channel “educational” may define client types who purchase products for the education industry. A channel “Web” might be used to define clients who make purchases from Web-based portals. A channel “Business Partners” might define business clients who provide co-branded services to their clients using the methods and apparatus of the present invention to obtain discount pricing of products and services for resale. Channels may be any type of logical grouping of clients and clients may be included in more than one defined channel.

A product hierarchy defines the structure and groupings of enterprise products and services by categories. A product category might be “Server Hardware/Software”. Another category might be “Desktop Hardware/Software”. Still another product category might be “Cables and Interfaces”.

Products, clients, and channels have specific attributes assigned to them that define what pricing adjustments will apply to pricing sequences used to calculate product and/or service pricing. Attributes can include physical descriptors and time-based indications. For example, a shipping weight for a particular product is an attribute of that product. A timetable covering a blanket purchase order negotiated with a specific client is an attribute of that client. Therefore, attributes define certain details about certain products, services, channels, and customers of the enterprise that weigh in when calculating specific pricing information.

Model framework 201 includes pricing factors. A pricing factor defines a pricing element or a pricing adjustment that is part of a pricing sequence. Examples of pricing factors include base price, cost, list price, local uplift, and so on. Model framework 201 includes pricing sequences, which are compilations of selected pricing factors. A pricing sequence is simply a list of factors that are executed in sequence to return a pricing result.

Model framework 201 includes bundles, which are definitions of certain product/service combinations that have special pricing considerations that are typically different when the products are provided separately. Bundling is commonly used by many enterprises as convenient vehicles for selling products and services. A computer, printer, monitor, scanner, and certain software can be provided as a bundled product attached to a specific service package making the service also part of the bundled product.

Model 200 uses pricing rules illustrated herein as rules 202 in order to resolve pricing requests. Pricing rules apply to general and specific combinations of products/services, customers, and channels. Pricing rules are created and are stored in a rules base that is part of the pricing model that is accessed by the pricing server component described with reference to FIG. 1 above. One or more pricing models 200 and associated rules are, in a preferred embodiment, stored in an object-relational, or other object-supported database. Through rules-based manipulation of the pricing model clients receive real-time pricing information in an automated fashion. One advantage that the system of the present invention has over prior-art systems such as the system of Carter described with reference to the background section is that when calculating pricing, only the rules for the specific factors in a sequence are navigated to determine specificity in pricing rather than the adjustments for all of the entire product and sales hierarchies above the specified product and customer indicated in an order for pricing. Only the rules specific to pricing request attributes are applied in calculation.

Pricing model 200 has validation tools 203 provided for the purpose of validating portions of the model and for generating templates for use in creating client, bundle, or category specific pricing lists for publishing. Test orders can be created and used to test the accuracy of specific portions of model 200 and are treated by the pricing model framework 201 as normal client-originated requests. Pricing templates are broad-based requests for pricing information and are specific to client type, channel, or category and can include bundle-pricing information and contract pricing information.

Model 200 can, in one embodiment, be configured as a generic but extensible pricing model wherein each request causes the system to build a version of the model that fits the parameters of the request. The pricing engine (analogous to server application 111 of FIG. 1) uses the model version that completely defines the client, channel, and product category, to generate the requested pricing results.

One with skill in the art of object-oriented presentation will appreciate that the system of the present invention not only decreases the need for storing tuples in numerous repetitive data tables, but reduces computation required of prior-art systems in drilling down to specific client and products ordered by considering everything in the trees above the position of the client and product in the tree. More detail regarding the computation process will be detailed later in this specification.

FIG. 3 is a block diagram illustrating the function of price sequencing according to an embodiment of the present invention. A pricing sequence 300 is illustrated in this example and comprises 2 types of sequences that are used to calculate pricing for an order. The 2 sequence types are labeled herein as an Order Sequence and an Item Sequence. Each type of sequence uses pricing factors. For example, an item sequence 301 is illustrated in some detail and has the listed factors Base Price, Local Uplift, Currency, List Price, Channel Discount, Final Price, Cost, and Margin of Profit. Note that the listed factors in sequence 301 are line item specific and are calculated for each item that pricing is requested for. Note also that the last 2 listed factors of sequence 301 are for internal use. They demonstrate an ability of the system to provide internal-use information like calculating a gross or net profit margin from a calculated cost figure.

An order sequence 302 is illustrated as the other type of pricing sequence and is used in the calculation of orders containing more than one product. Under factors listed in sequence 302 there is a Total Base Price, a Total List Price, a Total Customer Discount, a List Price, a Channel Discount, a Final Price, a Cost and Margin for Profit. It is noted herein that an item sequence is used to calculate pricing for a single item while an order sequence is used to calculate the sum totals of all of the line items of an order providing a “Total” figure. Singular discounts may also apply to an order such as a channel discount. Item sequence 301 is also used to produce line item price lists, such as illustrated price list 303 for clients. Price list 303 contains a heading for indicating which customer or customers the list applies to, which channel or channels to apply, the line item sequence or sequences used to process the items on the list, and the actual list of products and the itemized pricing figures adjacent to the appropriate items for pricing. Order sequences are always used to process customer orders such as illustrated order 304.

In a preferred embodiment of the present invention pricing requests can comprise actual requests for pricing initiated by clients prior to order placement and actual client orders where the pricing information is simply used internally for billing the processed orders. In the later case, typically the line item pricing, discounts amounts, and order totals are displayed for clients to view at the time of transaction.

A simple 3-step process for calculating orders and/or pricing requests starts when the “pricing engine” analogous to application 111 described with reference to FIG. 1 receives a pricing request as a first step. The pricing application then accesses and fires rules in a second step to determine values of factors used in the pricing sequence or sequences. At step 3 the pricing engine serves the calculated pricing results back to the requester in the case of a simple request for pricing and/or uses the results for billing an actual order.

FIG. 4 is a block diagram 400 illustrating relationship between the pricing engine 402 and a rules base 403 according to an embodiment of the present invention. Diagram 400 logically illustrates the 3-step method mentioned above. Pricing engine 402 is analogous to application 111 described with reference to FIG. 1. A pricing server 401 encapsulates engine 402 and is analogous to server 110 described with reference to FIG. 1. Engine 402 executing from pricing server 401 is adapted to accept incoming requests for pricing, which may include actual orders for products and/or services.

Incoming requests are illustrated herein by an arrow labeled Requests in. Incoming requests for pricing may be queued for engine 402 in a variety of different ways. The actual form of incoming requests will depend in part on the enterprise system environment and channels of operation. The system of the invention can be adapted to all known communications methods for placing orders and requests for pricing to an enterprise. Telephony IVR interaction, Web-form submission, e-mail orders, voice-assisted attendant orders, electronic fax orders, and orders submitted through special graphical user interface (GUI) components represent requests filtered through various interfaces that are fulfilled in automated fashion without human input. Telephone orders, telephone fax orders, and standard mail orders, can be intercepted by human operators and fulfilled with a pre-step of human assisted data entry. Once all of the required parameters of an order or pricing request are available to the system, the system can calculate the pricing and close the transaction, in case of an order, or submit a price quote in the case of a request-for-quote.

Once a request having all of the proper parameters is registered within engine 402, a rules base, illustrated in this example as rules base 403 is consulted. Engine 402, relying on server network communication capability between server 401 and rules base 403, causes a search for all of the rules that are applicable to the recognized parameters of the order or pricing request being processed. Rules base 403 is analogous to a rules base as part of a pricing model stored within PMR 112 described with reference to FIG. 1. Rules base 403 may, in one embodiment, be held separately from any pricing models and model tuples. Rules base 403 contains all of the created rules that the pricing model uses to resolve pricing. Rules can be created that apply to specific products, customers, and channels. Rules may be time sensitive and have effective dates and expiry dates. Rules may be created for specific pricing factors, and to volume orders having minimum order number and maximum order number ranges.

Although not illustrated in rules base 403, rules may also be created for special situations like contract dates, tiered pricing, scope pricing, and bundle pricing. An important aspect of the present invention is that engine 402 accesses rules base 403 for a request being processed and considers only those rules found that apply to the pricing factors of a pricing sequence and that match parameters present in the request. Therefore, rules contained in rules base 403 that have nothing to do with the factor value being determined are not accessed at all. Furthermore, no pricing sequences are finalized for calculation until the rules that apply have been processed for specificity. In other words, if a set of rules for a factor in a pricing sequence is found that applies to a particular product listed in the request, those rules are processed according to all of the other parameters also contained in the request until only a single applicable rule remains for the product listed. Rules found for each of the other parameters are processed accordingly until the specific rules are found that exactly fit the request. More about conflict resolution of rules in pricing is provided later in this specification.

FIG. 5 is a process flow chart 500 illustrating steps for building a pricing model according to an embodiment of the present invention. As previously described above, a pricing model is used for the purpose of enabling automated pricing calculations based on an applicable set of rules. In order to create a viable pricing model an enterprise must define and create the various components of the model. Chart 500 illustrates the basic steps of the process. At step 501, a user determines what existing pricing methods and pricing factors are currently used in that enterprises existing pricing scenario. In some cases, an enterprise may already have some basic pricing system of prior-art, which may already have a hierarchal structure for customers and products with certain pricing adjustment formulas and sequences that are currently used. All of these components that will be re-used in some way are isolated.

At step 502, the user may import all or some of the old product and sales hierarchies, if they exist, into a pricing manager application analogous to PM 114 described with respect to FIG. 1 above. PM 114 is able to translate the data format used to store the former data into a data format suitable to the pricing model. API language translators are available to and known to the inventor that can import the necessary data into the format required for model representation of the sales and product hierarchies. In one embodiment the sales channel (if used), and product hierarchies are created from scratch. In still another embodiment, some of the existing data is imported for convenience but significant re-structuring and possible addition of new categories is practiced. Data can be selected and imported into the PM application or keystroke methods typically available to computer interfaces. In case of old legacy storage systems, a suitable middleware can be installed to provide access and efficient use of the previously stored data. In addition, the pricing model can be generated from existing data.

Sales/channel and product hierarchies enable reduction in the number of rules considered for any specific pricing requirement. The flexibility built into the pricing model enables assignment of individual products into one or more product categories and individual customers or channels into one or more customer/channel categories in the trees. An enterprise has the ability to reorganize any part or all of a hierarchy and can make “group updates” into a hierarchy without repetitive entry.

Once the hierarchical structure of customers/channels, and products/services are set up, at step 503 the user defines all of the attributes and assigns them to their applicable customers, products, and channels. Attributes are the conditional variables that the pricing factors will consider when a pricing sequence is executed. More particularly, an attribute is a changeable numeric or alphanumeric property of an object (object orientation). An attribute can be modified to represent different values as may be required. Attributes are created by defining the attribute definition and association rules and then by assigning a default value to each attribute. A user may associate one or more attributes to specific customers, specific channels, or to specific products. Because attributes are “object properties” they, of course are not assignable to object groupings (categories).

At step 504, the user defines the pricing factors that will be used in pricing sequences. The pricing factors are the building components for the pricing sequences used to calculate item and order pricing. A pricing factor performs a mathematical or logical operation. Some factors are computational factors whose values are simply used as input for another factor in a pricing sequence. In typical pricing scenarios a first factor defined, say for a particular product might be a base cost or a base-pricing factor. The user can name such a factor simply as Base Cost or Base Price and assign a value to the factor. Note that the first factor of every sequence must have an assigned value to enable the sequence. Other factors will have values determined by rule. More detail about creating a factor will be described later in this specification.

At step 505 the user defines all of the pricing sequences that will be used to calculate prices. There are actually 3 types of pricing sequences that apply to pricing scenarios. Two of these, item sequences and order sequences were described briefly above with respect to the text description of the example of FIG. 4. The third type of pricing sequence is an item/order sequence. An item sequence is used to produce line item pricing such as required for price lists and customer orders. An order sequence is used to produce order totals and summaries. An item/order sequence is a single combined sequence used to calculate both line item pricing and order summary calculations. It is important to note that while many different item and order sequences may be created from factor combinations, most enterprise pricing models will rely basically on a default sequence of each type.

At step 505 the user defines all of the pricing rules that will be used to determine which values pricing sequences will use in calculation. As previously described, PM uses rules to determine which values will be assigned to pricing factors of pricing sequences. A pricing rule is applied to a specific pricing factor. Pricing rules may include an effective date range; a specific set of one or more sales categories and/or a specific customer; a specific set of one or more sales categories and/or an individual channel; a specific set of one or more product categories and/or a specific product; and a numeric minimum and maximum range or an alphanumeric value. More than one rule may be assigned to a specific pricing factor. The only time a rule assigned to a pricing factor is considered during a pricing sequence is when the conditions of the rule are consistent with the parameters listed in the pricing request being processed.

There are different types of rules that might be created for different types of pricing scenarios such as standard pricing rules, scope pricing rules, and bundle pricing rules. Rules can have more than one condition making it a compound rule that is assigned to more than one position on a hierarchy of product, customer or channel. The specificity of rule conflict resolution determines which values to use for the factors in any given pricing sequence. For example, if a pricing request comes in for a computer monitor abc, a printer 123, and a computer processing unit xyz, there may be individual rules pertaining to each of those products sold alone, and a special rule for those specific products sold together (bundle). In this case, the bundle rule might override the other product-specific rules. The invention does not have to consider any rules whose conditions do not match parameters of the request or that apply to any other factors aside from the factor that a value is being determined for. This fact makes the drill-down to specificity much more efficient than prior-art pricing systems. At step 507, the user may use the validation tools available with the pricing software to generate test pricing and order scenarios to test the accuracy and integrity of the pricing model in operation.

An innovative aspect of the present invention is that rules selected for setting the value of a factor when pricing a particular request are executed only if the rule constraints of the particular rule identified for the factor match the parameters listed in the request for pricing at a highest specificity. A unique process of conflict resolution is practiced to eliminate candidate rules from consideration.

FIG. 6 is a process flow chart illustrating steps for applying rules to factors before calculating prices according to an embodiment of the invention. At step 600 a request for pricing is received for processing. The request can be an actual client-placed order, a request for quote, a request for generating a price list, or a test request for model validation. The request is received by a PS application analogous to application 111 described with reference to FIG. 1 above.

At step 601, the PS application accesses a rules base, illustrated herein as a rules base “A” drawn in association with step 601 and searches for and identifies all rules that exist for each factor of the first pricing sequence used to calculate the line item pricing for the products and/or services listed in the request. It is important to note herein that in a preferred embodiment PS software determines which pricing sequence to use before rule identification because the rules are used to determine the values for the factors of the pricing sequences. Typically, an item sequence will be the default first sequence of a pricing request.

At step 602, the PS application sorts the rules for the first factor of the sequence and subsequent factors in a pricing sequence based on matching rule conditions against parameters indicated in the pricing request data. Possible request parameters of the pricing request received at step 600 are illustrated in this example as a request parameter list “B” drawn in association to step 602. Request parameters will logically include a date of request, which may be an order date if the request is a client order. If the request is associated with a previously drawn contract a contract date will be one of the request parameters. The customer originating the request will be identified. If the request is a test or an internal request, the customer parameter will reflect the request originator.

If the request is an order and channels are defined in the pricing model sales hierarchy than the request will identify the customer channel. Customer, channel, and item attributes can be made part of the request if applicable during run time after the request is received. An order quantity of a same item is an attribute. The request will identify and list the products and or services to be priced. The request will be assigned one or more pricing sequences by default, however other pricing sequences can be applied at run time based on resident request parameters or run-time attributes.

Referring now back to step 602, only rules for a factor that apply to all of the request parameters are extracted for conflict resolution. Other rules that did not have conditions that applied to all of the request parameters are ignored at step 603, which is another enhancement over prior-art systems. Steps 602 and 603 are repeated for all rules of each factor in a given pricing sequence in lieu of certain exceptions described further below. Factor rule sorting is based on examining rule constraints or conditions and matching those constraints or conditions against request parameters contained in the request being processed. Two exceptions to step 602 exist, the first one being that if a factor specifies an attribute override then instead of accessing rules for that factor, the pricing engine (PS 111, FIG. 1) accesses the value pre-assigned to the attribute indicated and assigns that value to the factor and then moves to the next factor. The other exception is that if the factor is a computational factor, there are no factor rules existing for that factor and its value is derived from computing the two previous factor values in the sequence (value derived “from factor 1 and from factor 2”). Such a factor must have two previous factors listed in the sequence.

It is noted herein that multiple rules may be created for a single pricing factor. In the case of multiple rules, such rules apply to the specified factor under certain conditions built into the rule definitions. For example rule conditions for application to any particular factor can be based on one or a combination of products and their specific locations in the product hierarchy, customers, channels, effective and expiry dates, contract dates, order dates, and conditional variables. The ability to apply multiple rules to a pricing factor enables much more flexibility for pricing different scenarios than prior-art systems do. For example, customer-specific pricing differences can be applied to a same product. Same products can be priced differently from one another based on the particular product categories to which they belong. Pricing differences of same products may also be based on date purchased, date required, contract date agreements and so on.

It should be noted herein that for conflict resolution, there is provided a default conflict resolution order list that is adapted as a template used to resolve specificity of rules qualifying for a given factor. The list is illustrated herein as Conflict Resolution Order “C” drawn in association with step 604 described further below. The default order of parameters for conflict resolution are Customer; Product/Service; Date; Channel; Attribute; and Value. The last parameter is a tie-breaking parameter for any number of rules greater than one rule of a set of rules that all qualify at a same specificity to set the factor value according to all of the conflict resolution parameters.

Referring now back to step 603, rules that are found for a given factor that do not apply, at least generally, to all of the pricing request parameters of a particular request being processed are eliminated from consideration or ignored. Only the factor rules that contain or apply to all the parameters contained in the request for pricing are aggregated for conflict resolution. This fact reduces the amount of computing resource that is dedicated to the process, as not every rule that applies to the factor is considered as a candidate factor rule capable of setting the factor value, All candidate factor rules for conflict resolution have rule conditions that roughly match the stated parameters in the pricing request.

The exact level of granularity for initial rules sorting against parameters can be configured when rules are defined for the factors. For example, in a low level of granularity all of the rules for a given factor that are found to at least contain all of the condition fields that match with the request data fields may be considered to qualify for conflict resolution. In a preferred embodiment the request data has at least an order date, a customer I.D., a channel I.D., product I.D. and optionally, a product category I.D., and any attributes like quantity ranges.

Therefore, any rules for a particular factor that qualify after sorting in step 602 are resolved against each other using the above-mentioned conflict resolution order as a template. The goal is to resolve down to a single most specific rule to apply to the considered factor.

At step 604, if there exists more than one rule after sorting for a given factor, those rules are analyzed and ranked according to specificity of their conditions matching the request parameters using the conflict resolution order according to the default order of parameters stated in list “C”. It may be that only one rule for a considered factor passes the processes of steps 602 and 603. In that case step 604 is not required and the process skips to step 605 where the value of that rule (being most specific) is assigned to the factor. Comparison is made by drawing the node paths of the condition against the node path of the matching parameter of the request. The rules are compared for the first parameter of conflict resolution order “C” and then again for the second parameter and so on down the list.

Any logical ranking system may be employed. In one embodiment a simple ranking system of real numbers is used wherein simple numbers like 1, 2, 3 and so on are employed. In this case, 1 is a highest ranking (closest specificity to parameter while 3 is a lowest ranking of the just-mentioned ranking numbers. Tokens, binary numbers, or other numeric criteria may also be used. During comparison the node paths specified in each parameter of a request are compared against the associated node paths specified in the rule conditions of each compared rule according to the order stated in list “C”. This means that the remaining rules applying to a given factor after step 603 are first compared for “customer” specificity to the specificity of “customer” contained in the request. If for example there are 4 rules and 1 rule specifies a root node “All”, one rule specifies a customer category “re-sellers”, 2 rules specify “Jack” as a customer, and the request path for customer specifies “Jack”, then the first rule receives a ranking of 3, the second rule receives a ranking of 2 and the remaining rules receive a ranking of 1. The rules ranking 3 and 2 are eliminated from consideration, however the remaining rules are tied and must be compared now according to the next listed conflict parameter, which is product. The process repeats for all of the conflict resolution parameters until there is only one rule left.

In one embodiment, there may be no rules that, for example specify the exact customer listed in the request, but there are rules that specify, perhaps the customer category “Re-sellers” and the root node of the customer hierarchy “All”. In this case, the rules specifying “Resellers” would get a ranking of 1 and the rule specifying “All” would get a ranking of 2 because “Resellers” is positioned in the sales hierarchy closest to the specified customer “Jack”, if Jack is categorized as a reseller.

If in step 604 there are multiple rules that receive the highest rankings for both customer and product, then they are compared for specificity according to date as it applies to rule effective and expiry date ranges. For example, assume that the order date parameter of the request is Apr. 25, 2003. Assume 2 remaining tied rules wherein one of the rules has an effective date of Apr. 20, 2003 and an expiry date of Apr. 30, 2003. The other rule has an effective date of Apr. 20, 2003 and an expiry date of May 15, 2003. Both rules have date ranges that include the order date of the request, however the rule with the more constrained range is assigned a ranking of 1 and the other rule a ranking of 2 breaking the tie for the parameter date. If there are 2 rules having date ranges that are equal in length wherein the request date falls within both ranges, then the rules remain tied and the next conflict resolution parameter of “Channel” is used to compare the rule specificity. The system assigns a higher priority to a rule with only one open-ended range end for date compared to a rule with both range ends open. However rules that are open ended on opposite range ends when compared remain tied.

Additional rules for specificity apply when a factor specifies a conditional alphanumeric attribute or a numeric attribute like volume. In the first case a rule is qualified for the factor if the alphanumeric value in the rules exactly matches that found in the request and conflict resolution is not required. In the second case rules are sorted by maximum and minimum ranges for a numeric attribute listed in the pricing request and the range that is the most constrained receives the highest ranking similar to date range processing.

It may be the case that two or more rules succeed to the last parameter of the conflict resolution order parameter listed as “Value” in list “C”. In this case a factor definition flag set to highest or lowest value for tied rules in conflict resolution is applied to break the final tie. By default the system selects the rule having the highest value.

At step 605 the value specified by the last remaining rule is assigned to the factor. If there were 2 or more rules that were tied wherein the assigned values had to be decided by a pre-set value determination of lowest or highest value, then the rule with the lowest or highest value is assigned to the factor at step 605 depending on a flagged indication found in the factor definition.

It will be apparent to one with skill in the art of data conflict resolution that the exact steps of the process represented herein may vary somewhat in description and granularity without departing from the spirit and scope of the present invention. For example, conflict resolution may, in one embodiment, ensue until each rule has been thoroughly compared according to every parameter on the conflict resolution list “C” before any ranking is assigned. In this example a ranking and elimination sequence occurs once for each factor of list “C” until rules are eliminated by receiving a ranking of lower than a highest ranking rule in the same set for comparison.

FIG. 7 is an elevation view of a main user-interface screen 700 for practicing the present invention. Screen 700 is a main user interface for enabling management of the various components of the invention. Screen 700 is the user interface for PM software 114 running on desktop 113 described with reference to FIG. 1 of this specification. Screen 700 can be provided as a LAN-based or Web-based application wherein authorized users make access by performing a login procedure from a login screen. Screen 700 has a resident face 701 and a transition window 702.

Face 701 has a list of selectable options arrayed generally in a column on the left side of the main interface. Reading from top to bottom from the list, the selectable options are Product Hierarchy (Product Hier.), Sales Hierarchy (Sales Hier.), Pricing Rules, Pricing Factors, Pricing Sequence (Pricing Seq.), Attributes, Bundles, Pricing List Templates (P.L. Templates), Model Validation Tools (Model Val.), and Pricing Administration (Pricing Admin.). In this example, the selectable option Pricing Rules is highlighted causing display of “All Pricing Rules” in transition window 702.

Resident screen face 701 has a search function field 705 and selectable control icons New, Edit, Copy, Delete, and Add. Screen face 701 also has a Help option, an About option, and a Logout option arrayed at top right of the screen face. Transition window 702 displays all of the pricing rules that have been defined for a particular pricing model. Interface 700 has scroll functions 704 and 703 for vertical and horizontal scrolling. Rules 50 through 56 are displayed in this example.

Each rule has an ID number and specifies a Product and Customer to which the rule applies. Each rule also specifies a Channel or Channel category. Some of the rules have effective dates and expiry dates indicated. Each rule identifies a particular factor to which it applies. Using main interface 700, rules can be copied, deleted, edited and added. Navigation through the list of selectable options and selection of those options cause transition window 702 to display new interactive window contents associated with the selected option. All pricing management functions are accessible and enabled through interaction with main interface 700.

FIG. 8 is an elevation view of a sub-interface 800 invoked from interface 700 for creating a new factor according to an embodiment of the present invention. Interface 800 can be identical to interface 700 described above in terms of the resident portion of the interface. For example, the list of selectable options described with reference to interface 700 on resident face 701 is also represented on the face of interface 800 in this example. The search function and control functions described with reference to face 701 of interface 700 may also be present in this example although they are not illustrated.

Interface 800 has a transition window 804 that is displaying a form for creating a new pricing factor. Scroll functions 801 and 802 are provided for scrolling window content as previously described. The form or layout of window 804 begins at the top with a field for entering a name (Factor Name) for the new factor. A next field is an entry field with drop-down options enabling a user to select an Operation Type for the new factor. In this example a % decrease is displayed in the entry box.

A next entry field (From Factor) is provided to select an associated factor in the sequence. In this case the previous factor in the sequence (Prev. Factor-Seq.) is selected from a drop-down menu. A next entry field is provided to enable selection of a factor Type from a drop-down menu. In this case the type is Standard. A check box is provided for the user to set an indication of Scoped to the factor if it will be used in a scope pricing calculation.

An option field for selecting the type of condition variable for the factor is provided (Cond. Var. Type) with the options of Attribute and Factor. A next entry field enables the user to select the variable condition (Cond. Var.) from a drop-down menu. A next entry field (Rounding Method) enables the user to select the mathematical rounding method for results from a drop-down menu. In this case −2 (0.01) is selected.

A field box 803 is provided to display the current order of conflict resolution parameters. In this case the default order is displayed with the first parameter used on top of the list. A next selection field (Value Priority) enables a user to set the tie-breaking value preference to Higher or Lower. At the end of the form there are selectable options for Apply, OK, and Cancel. Using interactive form 804, a user can create, copy, edit, or delete factors.

Selection of other selectable options arrayed on the left face of interface 800 causes to appropriate transition windows to display the required interactive forms and content associated with user selection.

It will be apparent to one with skill in the art that graphical design of interfaces 700, 800, and all subsequent display, screens, interactive forms, and so on is strictly a matter of design preference of which there may be many variations.

Product-Scope Pricing

Although product-based pricing is the default set-up for the software of the present invention, product-scope pricing rules can be created for applying different prices for a same product offered in different categories. Extending the pricing model for product-scope pricing involves 3 basic steps.

FIG. 9 is a process flow diagram illustrating basic steps for setting up scope pricing according to an embodiment of the present invention.

At step 900 a particular product, which may be a service, is assigned to appropriate product categories. Each category will occupy a different level on the product hierarchy. It is assumed that an instance of the product will have a different price for each of the categories.

At step 901, the appropriate pricing factors are defined based on the product locations in the product hierarchy. The factor scope flags are set in this step to on or checked, as is the case of the form described with reference to Fig.8.

At step 902, the user creates a separate rule particular to each instance of the product at the different hierarchical location paths assuming different pricing will be the case for the product instance in each separate category. When creating a rule for the product instance, selecting the appropriate product instance from the tree automatically loads the correct path information into a “scope field” associated with the rule.

Contract Pricing

Contract pricing enables price calculation based on prices that were in effect at some point in the past. For example, assuming that current rules exist for assigning the base price of a product in the current year. A contract-type rule can be created for a specific customer that is currently in effect, but sets the base price of the particular product to the price that was in effect during the contract date specified in the pricing request. In creating the rules for contract pricing, a contract date is added to the rule for each factor used so that when the rule is fired the input value for the rule will be calculated based on rules in effect at the time of the specified contract date.

To further illustrated assume that an item pricing sequence of factors is as follows:

| Factor | Operation Type | From Factor | From Factor 2 |
|---|---|---|---|
| Base Cost | Value Override | N/A | N/A |
| Base Price | % Increase | Base Cost | N/A |
| Cust. Disc. | Multiplication | Base Price | Value from Rule |
| Margin | Subtraction | Base Price | Base Cost |

The rules for the factors in the sequence are:

[Rule ID 1 Factor Name Base Cost Product P4 1.5 Customer All Channel All Eff. Date Jan. 1, 2002 Expiry Date Dec. 31, 2002 Contract Date None Value 1400]

[Rule ID 2 Factor Name Base Cost Product P4 1.5 Customer All Channel All Eff. Date Jan. 1, 2003 Expiry Date Jun. 30, 2003 Contract Date None Value 1500]

[Rule ID 3 Factor Name Base Price Product P4 1.5 Customer All Channel All Eff. Date Jan. 1, 2002 Expiry Date Dec. 31, 2002 Contract Date None Value 15]

[Rule ID 4 Factor Name Base Price Product P4 1.5 Customer All Channel All Eff. Date Jan. 1, 2003 Expiry Date Dec. 31, 2003 Contract Date None Value 15]

[Rule ID 5 Factor Name Cust. Disc. Product P4 1.5 Customer All Channel All Eff. Date Jan. 1, 2003 Expiry Date Dec. 31, 2003 Contract Date None Value 0.90]

[Rule ID 6 Factor Name Cust. Disc. Product P4 1.5 Customer Nexisl Channel All Eff. Date Jan. 1, 2003 Expiry Date Dec. 31, 2003 Contract Date Jan. 1, 2002 Value 0.90]

For an order having the following parameters:

Order Date Feb. 23, 2003 Contract Date Jan. 1, 2002 Customer Nexisl

Channel N/A Item LXLaptopp4 1.5 OTY 1

First the base cost is figured as of Feb. 23, 2003 order date and assigns the more specific value of rule 2 (1500) as the base cost value. The next item in the pricing sequence is base price as of the order date of Feb. 23, 2003. The pricing engine assigns a 15% increase based on the most specific rule 4 applied to the from factor value 1500 to render a value of 1725.

The next item in the sequence is customer discount. Because rule 6 contains a contract date as does the order, the pricing engine save the previously calculated results for base cost and base price in memory. Then the pricing engine recalculates the base price “From Factor” of rule 6 based on the contract date and qualifies rules 1 and then 3 to arrive at a new base price. The base cost value of rule 1 is 1400 so the engine calculates the new base price using 1400 from rule 1 and the value from rule 3 (15) to render 1610. The engine then assigns the value from rule 6 (0.90) for multiplication arriving at a customer discount value associated with the contract pricing of 1449. For the margin factor of the sequence, the engine fetches the previously stored values for base cost and base price and calculates a normal 225 value for margin as if the sale was conducted according to the current date pricing formulas.

Bundled Pricing

Bundled pricing refers to pricing products based on other products ordered with them as a package or bundle of products. Companies often bundle popular items with less popular items in order to “move” the less popular items that otherwise might not get ordered. Typically, a buyer receives more favorable item pricing if they order a bundle instead over ordering the same items separately. For example, if products A, B, and C are ordered together, the buyer may get a better item price for item C than if he had purchased it separately from items A and B.

FIG. 10 is a screen shot 1000 of a bundle creation and editing interface accessible through main interface 700 of FIG. 7. Interface 1000 can be invoked through interaction with the selectable option “Bundle” from the option list of interface 700 of FIG. 7. Interface 1000 has a resident face 1001 containing fields 1002 for entering the Name, Customer(s), and Channel(s) to which the bundle will apply, and the Effective and Expiry dates of the bundle. A field 1003 is provided for listing a bundle ID, in this case ID 100.

Interface 1000 has an editing window 1005 for specifying specific products and quantities for the bundle. A second editing window 1004 is provided for the purpose of specifying the particular adjustment values that are applied to the specific products that will receive pricing adjustments.

There are two special purpose factors that are created for bundling. These are a bundle detection factor and a bundle adjustment factor. A bundle detection factor specifies the minimum and maximum quantity constraints in the rules for each product or product category specified in the bundle. Referring now back to FIG. 8 (form for creating a factor), a created factor is specified as a bundle detection factor when its “operation type” field is set to “Bundle”. This action automatically sets the condition variable type field to “Quantity”.

Referring now back to FIG. 10, window 1005 has a field 1007 for selecting which bundle detection factor to use when creating a bundle. A scrollable screen 1009 is provided within window 1005 for enabling selection of which enterprise products to include in the bundle and for specifying the minimum and maximum purchase quantities required for bundle pricing qualification. In this example there are 4 products in a column for products that are selected as part of the bundle. A minimum quantity of 1 is specified for each product selected to be in the bundle. Support has no quantity attribute because it is a service. The service support however is included and customers are required to purchase the support service in order to receive bundle pricing in this example. Screen 1009 is a scrollable screen in this example using scroll control bar 1006.

Interface 1000 has an editing window 1004 provided for the purpose of identifying the products of the bundle that will receive value adjustments and for specifying those values. Window 1004 has a field 1008 for selecting the appropriate adjustment factor to use with the particular bundle factor selected in window 1005. The bundle adjustment and bundle detection factors are a cooperating pair. Window 1004 has a scrollable edit screen 1010 having a product column, a scope column, and a value column. The products of the bundle selected for the bundle in screen 1009 are selected only if they are to receive a value adjustment. In this case the products DVD-110 and Support are selected. The scope column is not applicable in this example because this bundle is for product-based pricing and not for scope-based pricing. For each selected product, its adjustment value is input into the value column.

The pricing engine uses the bundle adjustment factor to determine the type of price adjustment and which factor in a pricing sequence to apply the adjustment. The pricing rules created for this factor specify the adjustment amounts to apply to the qualifying products. Referring now back to FIG. 8, when the bundle adjustment factor is defined to use the bundle detection factor, the operation type field (see FIG. 8) must be set to any of the appropriate arithmetic operations, % decrease, % increase, addition, subtraction, multiplication, or division.

The type field of the bundle adjustment factor must be set to “Bundled”, and the condition variable field must be set to factor and specify the associated bundle detection factor to use. Bundled pricing may be practiced for either product-based pricing (scope flag off) or product-scope pricing (scope flag on).

Referring now back to FIG. 10, the adjustment value of 25 is assigned for DVD-110 for this particular bundle and the value of 50 is set for the support services included in the package. The values will apply to the particular operation type of the selected adjustment factor listed in field 1008.

In the case of bundle creation, the pricing engine can automatically generate the pricing rule sets that will apply to the bundle. The pricing engine only creates rules based on what is entered (rules) in the Pricer manager. So no rules are automatically created—only ones defined in Pricer manager. Multiple rules may be created to use the same bundle adjustment/detector pair of factors. In a preferred embodiment one pair is used to handle the entire bundle pricing needs of the enterprise. However that is not to say that more than one factor pair cannot be used to define a bundle.

Each bundle rule created for a bundle detector/adjustment pair specifies the bundle ID. The bundle ID is used to identify a set of bundle rules for the operation of qualifying rules and for the operation of resolving rule conflicts between different groups or sets of bundle rules. The bundle ID is assigned to the “value” field in bundle detection rules and to the “Min/Max” fields in the bundle adjustment rules. Refer to FIG. 4 element 403 (pricing rules) to identify the appropriate data fields for the bundle ID.

Each bundle rule also specifies customers that qualify to receive the bundle; channels that qualify for the bundle; effective and expiry dates for offering the bundle; the products and/or product categories that must be included in a pricing request to qualify for receiving the bundle pricing; and the pricing adjustments that are to be applied to each product in the bundle that will receive adjustments. Since all of these parameters are known to the system before the rules-sets are generated, the pricing engine can generate all of the rule sets for each pricing factor. Again, no rules are “automatically” created. They are defined in Pricer manager and translated by the Pricer engine.

Conflict Resolution (Bundle)

There can be many sets of bundle rules created for a single bundle detection factor as previously described above. All of the rules created for a particular bundle detection factor have the same assigned value, which is the bundle ID value. For example given a bundle with ID 100, all rules for that bundle will have the ID 100 assigned in the appropriate rule fields.

FIG. 11 is a process flow chart illustrating steps for qualifying bundle detection rules for a bundle detection factor. At step 1100, the pricing engine identifies all of the rules for a particular bundle detection factor that include the specific bundle item that the engine is pricing including if applicable, any of the item's ancestor categories in the product hierarchy.

At step 1101, the pricing engine sorts through the rules based on the bundle IDs assigned to each rules value field and discards any rules specifying products and quantities that are not included in the order being priced.

At step 1102 the pricing engine qualifies the remaining rule sets based on customer, channel, and date specifications. Within each set of remaining rules the values for customer, channel, and date must match the order values or the entire rules set is discarded.

At step 1103, it is determined whether one set of rules or more than one set of rules with the same bundle ID has qualified to set the factors value. If at step 1103 there are more than one qualifying set of rules, then at step 1104 the pricing engine performs conflict resolution between the sets of rules using the conflict resolution order specified in the factor. It is noted herein that conflict resolution in the case of bundling is performed only on different sets of rules for different bundles and not within a set of rules for any given bundle detection factor.

If in step 1103 there are not more than one set of rules that qualify then the pricing engine applies the set of rules to the pricing factor at step 1105. In this step the pricing engine assigns the bundle ID value of the winning rules set to the bundle detection factor.

In conflict resolution for bundles, the pricing engine skips resolving conflicts between rules sets based on product because several products can qualify for a bundle. It also skips conflict resolution based on attribute because all bundle detection rules are based on a quantity attribute. Customer, channel, date, and value are the criteria for conflict resolution for bundle detection factors. If conflict resolution does not provide a tie breaker after applying the customer, channel, and date criteria then the value criteria is used to break the tie according to what value state that the detection factor is set to (higher or lower). Which ever is true, the pricing engine assigns the highest or the lowest value (Bundle ID). If there are no rules sets that qualify then the pricing engine simply assigns 0 as a value for the detection factor. After the process as described herein is complete including any required conflict resolution, the pricing engine performs rule qualification and, if required, conflict resolution for the associated bundle adjustment factor.

FIG. 12 is a process flow chart illustrating steps for qualifying bundle adjustment rules for a bundle adjustment factor. At step 1200 the pricing engine first identifies all of the rules for the adjustment factor that include the particular product, or product categories as described for detection factors with reference to the process order of FIG. 11 step 1100. At step 1201 the pricing engine checks the Max and Min constraints of each rule against the value of the specified condition variable of the factor, which is the value assigned to the associated detection factor.

At step 1202 the pricing engine quantifies the number of matching rules. If at step 1202 only one adjustment rule is found to exactly match the value of the bundle detection factor then at step 1204 the pricing engine assigns that value to the bundles adjustment factor. It is noted herein that the bundle detection rules should be qualified first as described above with reference to FIG. 11.

At step 1202 if more than one adjustment rule is found that matches the bundles detection factor value then the process resolves to step 1205 for conflict resolution. Conflict resolution is performed according to the factors specified in the conflict resolution order of the factor.

In conflict resolution of rules for an adjustment factor, the pricing engine does not resolve conflicts based on attribute because the attribute assigned to all of the rules for the bundle adjustment factor is the same (the associated bundle detection factor value). The pricing engine does perform conflict resolution based on customer, product, channel, date, and value.

If no rules qualify to set the adjustment factors value then depending on the definition of the adjustment factor the pricing engine “assigns either the value from the previous factor in the pricing sequence”, or the value of the bundle adjustment factors specified “from factor”. It is noted herein that the value of the “from” factor could be the previous factor in the sequence.

Tiered Pricing

The software of the present invention, in addition to enabling product-scope pricing and contract pricing, also enables tiered pricing, sometimes termed “stair-step” pricing in the art. Tiered pricing involves breaking down the quantities ordered for a product item and pricing the item based on those quantities fitting into specific quantity ranges. It is a vehicle that allows volume-discounting structures.

Using the previous contract pricing example of an LX P4 1.5 Laptop computer assume that there will be a volume discount of 5% for the first 9 computers ordered, a 10% discount for an additional 15 computers ordered on the same order, and a 15% discount for the next 25 or more computers ordered.

According to a preferred embodiment, the pricing engine (PS 111 FIG. 1) uses a weighted algorithm for computing such tiered pricing. If an order for 30 computers arrived using the tiered pricing structure listed above, the weighting algorithm renders a % figure that reflects a weighted average over all of the computers. The method is continued below.

| Quantity | | Discount (%) | |
|---|---|---|---|
| 9 | * | 5 = | 45 (value) |
| 15 | * | 10 = | 150 (value) |
| 6 | * | 15 = | 90 (value) |

The sum total of the discount values multiplied by the individual volume values for each discount is 285 (45+150+90). The sum total is then divided by the total quantity of computers ordered (30). The average value for each computer on the order then is 9.5. The average value is represented as a percentage of discount reflecting a percent average of discount for the total number of computers ordered or 9.5%.

FIG. 13 is a process flow diagram illustrating basic steps for setting up a tiered pricing scenario. At step 1300, a pricing factor definition is created for the factor that will be involved in the tiered pricing structure. For the example above, the factor created is a volume discount factor. The process of creating a factor is generally followed as discussed with reference to FIG. 8 above using the appropriate interactive form 804 and the offered fields. One with skill in the art can generally follow the order of field in form 804 of FIG. 8 to visualize this example.

Part of step 1300 is selecting the operation type of the factor, in this case, % Decrease. Specifying the “From Factor” as “The previous factor in sequence” is appropriate. Condition variable “Type of Attribute” must be selected with the condition variable being quantity. “Tiered” must be displayed in the Factor Type field. Specify the remaining factor fields as normally required.

At step 1301 the rules for the factor are defined for the appropriate products, customers, and/or channels. For the purposes of this example, the following rules are created:

1. Volume Discount; LX P4 1.5; All; All; Jun. 1, 2002; Dec. 31, 2002; Qty range Min.=0 and Max 9 with a Value of 5 (assigned during run time).

2. Volume Discount; LX P4 1.5; All; All Jun. 1, 2002; Dec. 31, 2002; OTY range Min.=10, Max=24, with a Value of 10.

3. Volume discount; LX P4 1.5; All; All; Jun. 1, 2002; Dec. 31, 2002; Qty. Min.=25; Max=infinity, with a Value of 15.

All of the just-listed rules are identical to each other except for differences in values and attribute ranges (quantity ranges).

At step 1302 a text order reflecting a stated quantity of computers is generated as a test validation tool. Note that no conflict resolution occurs; rather the pricing engine fires all of the rules for that particular factor (volume discount) and determines the weighted value as previously described. However, in an unusual case where rules may have conflicting ranges such as perhaps, a rule missing an intermediary range; ranges between rules that overlap; or ranges that are open ended on one end of the range, a type of conflict resolution takes place. For example, the range conflicts are resolved by an additional master rule that governs priority setting for tiered rules.

To further illustrate, if one of a set of rules is missing an intermediate range not covered by any other rule in the set and no value in another range rule can be set for that range rule than the pricing engine assigns a 0 value for that particular missing range according to a master rule. If a missing range as described above can be covered in another rule that has an open end on one side of its range, than the missing range is covered by the value of the rule that covers it by open ended instance either at the MAX or MIN side of the range. As such rules with an open-ended range side take priority over any rules that are totally open ended with respect to range. For rules that have overlapping ranges, the rule with the smallest range takes precedence according to master rule.

The pricing system of the present invention can be practiced in an automated fashion over a local, or wide area network including the Internet network and any sub networks connected thereto. A wide variety of platform interfacing systems can be adapted through API to send pricing requests to and receive pricing results from the pricing system of the present invention including but not limited to Web portals, Wireless Gateways, CTI-Telephony Switches gaining access through network bridging techniques; Web servers; Alternative Computing Platform GUIs, and so on. The methods and apparatus of the present invention apply not only to product-based pricing, but also scope-based pricing, contract-based pricing, tiered pricing, and bundle pricing scenarios. Likewise, the system of the invention can be adapted for different client needs like automated business-to-business pricing communication, internal operative requirements for list generation and reporting, client to business pricing communication for automated order placement, and so on.

In one embodiment of the present invention, the system is adapted for provision of automated pricing based on client-configured models for items that can be accessorized in different ways. For example, a client operating an enterprise-provided product/service configuration application from a remote interface can create and submit various configurations of a product like an automobile for example, and receive the updated pricing information for the product in its various configurations. An example would be to configure an automobile with basic features including color, engine type, etc. and receive a price based on the specific configuration and then to add certain offered accessories like a sun roof, navigation system, etc. and receive the updated pricing for the automobile having the specific accessories.

The methods and apparatus should be afforded the broadest possible scope under examination according to the many possible use embodiments. The spirit and scope of the invention should be limited only by the claims that follow.

What is claimed is:

1. An automated pricing system for calculating pricing for items and item orders comprising;
a server node connected to a data network for serving pricing information;
a pricing application running on the server node for calculating the pricing information served; and
a data repository accessible to the server node for storing at least one pricing data model and rules for manipulating the model;
characterized in that the server node receives requests for pricing, accesses rules created for pricing factors used in at least one pricing sequence to price an item or items of the request and uses the pricing application to calculate the correct pricing results including sub totals and total amounts for the request based on sorting and/or conflict resolution of the rules accessed for each factor.

2. The pricing system of claim 1 wherein the data network is the Internet network.

3. The pricing system of claim 1 wherein the data network is a local area network connected to the Internet network.

4. The pricing system of claim 1 wherein pricing requests are received from a business-to-business server connected to the data network the requests generated in an automated fashion and routed to and queued in the pricing server for processing.

5. The pricing system of claim 1 wherein the pricing requests are received from clients accessing an enterprise hosted Web server connected to the data network, the requests routed to and queued in the pricing server for processing.

6. The pricing system of claim 1 wherein the requests are received from a client operating from a wireless network-capable device through a wireless interface having connection to the data network, the requests routed to and queued in the pricing server for processing.

7. The pricing system of claim 1 wherein the pricing requests are received from a third-party price configuration application running on a node connected to the data network.

8. The pricing system of claim 1 wherein the served pricing information is item pricing generated in the form of a pricing list.

9. The pricing system of claim 1 wherein the pricing information includes indication of profit margin for each item and for the order.

10. The pricing system of claim 1 wherein there are multiple pricing models applicable to different pricing methods.

11. The pricing system of claim 10 wherein the methods include product-based pricing, product scope pricing, contract pricing, tiered pricing, and bundled pricing.

12. The pricing system of claim 1 wherein there is one pricing model extensible to reflect multiple pricing methods.

13. The pricing system of claim 1 wherein the methods include product-based pricing, product scope pricing, contract pricing, tiered pricing, and bundled pricing.

14. The pricing system of claim 1 wherein the repository is part of a legacy system.

15. The pricing system of claim 1 wherein pricing rules are accessed and, sorted and resolved for conflict in sequence for each listed factor having rules in the order that each factor exists in the at least one pricing sequence staring with the first factor in the first sequence.

16. A software application suite for calculating prices for pricing requests received by the application comprising:
a pricing server component for calculating pricing based on pricing factors used in at least one pricing sequence;
a pricing management application for creating at least one pricing model and for updating and editing the at least one model;
a model validation component for testing the integrity of the at least one pricing model;
a pricing list generator for generating line item pricing lists; and
at least one application program interface for enabling third-party applications of varying platforms to communicate with the pricing server component;
characterized in that pricing requests received are handled in automated fashion for one or a combination of product-based pricing, product scope pricing, contract pricing, tiered pricing, and bundled pricing scenarios by matching rule constraints to request parameters for each pricing factor in a given pricing sequence used by the application to calculate pricing for a given request.

17. The software of claim 16 wherein pricing requests are received from a business-to-business server having data-network-access to the application suite, the requests generated in an automated fashion and routed to and queued in a machine hosting the server component of the application.

18. The software of claim 16 wherein the pricing requests are received from clients having data-network-access to an enterprise hosted Web server connected to the data network, the requests routed to and queued in a machine hosting the server component of the application.

19. The software of claim 16 wherein the requests are received from a client operating from a wireless network-capable device through a wireless interface having access to the application, the requests routed to and queued in a machine hosting the server component of the application.

20. The software of claim 16 wherein the pricing requests are received from a third-party price configuration application running on a node having access to the application, the requests routed to and queued into a machine hosting the server component of the application.

21. The software of claim 16 wherein the pricing information includes indication of profit margin for each item and for the order.

22. The software of claim 16 wherein there are multiple pricing models applicable to different pricing methods.

23. The software of claim 16 wherein the third-party applications use the at least one API for translating platform dependent markup languages to enable cross communication between a client platform and the platform hosting the software application.

24. The software of claim 23 wherein client platforms capable of cross-communication with the software application include CTI telephony platforms including Interactive Voice Response systems, platforms using Wireless Markup Language, Voice over Internet Protocol, Hypertext Markup Language, and Extensible Markup Language.

25. In an automated pricing system for calculating pricing for items and item orders, the system including a pricing application running on a server node, and a data repository accessible to the server node for storing at least one pricing data model and rules for manipulating the model, a method for price calculation of an item in the pricing request comprising steps of:
(a) receiving the pricing request for processing;
(b) identifying an item pricing sequence comprising pricing factors used in calculating;
(c) accessing the rules for the first listed factor in the sequence having associated rules;
(d) sorting the rules based on constraint matching to parameters in the request;
(e) eliminating those rules that do not match the request parameters;
(f) applying the value of the remaining rule that most closely matches the request parameters to the factor;
(g) repeating steps (c) through (f) for each factor in the sequence that has associated rules; and
(h) calculating the price of the item using the values assigned to the factors of the sequence.

26. The method of claim 25 wherein in step (a) the request has more than one item listed for pricing and the method is repeated for each item in the request using the same pricing sequence.

27. The method of claim 25 wherein in step (b) the pricing sequence is an item pricing sequence selected by default according to a pricing model.

28. The method of claim 25 wherein in step (c) the rules are accessed from a data repository containing the pricing model data.

29. The method of claim 25 wherein in step (c) the rules for the factor specify necessarily, the item being processed, a customer requesting the item pricing, and the sequence factor associated with the rule, and optionally, an item category associated with the item, an effective date of the rule, an expiry date of the rule, and the minimum and maximum quantity ranges of the item ordered.

30. The method of claim 25 wherein in step (d) the parameters in the request specify necessarily, a request date, a customer that initiated the request, the item being processed, and the sequence used to calculate the pricing, and optionally, a contract date, a sales channel, and attributes assigned to the customer, item, and channel.

31. The method of claim 25 wherein an additional step is required between steps (e) and (f) for conflict resolution in case of more than one candidate rule remaining after step (e).

32. In an automated pricing system for calculating pricing for items and item orders, the system including a pricing application running on a server node, and a data repository accessible to the server node for storing at least one pricing data model and rules for manipulating the model, a method for price calculation of the total figure of multiple items in the pricing request comprising steps of:
(a) after items have been individually priced using a pricing sequence, identifying an order pricing sequence comprising factors used in calculating totals;
(b) accessing rules for the first listed factor in the sequence having associated rules;
(c) sorting the rules based on constraint matching to parameters in the request;
(d) eliminating those rules that do not match the request parameters;
(e) applying the value of the remaining rule that most closely matches the factor;(f) repeating steps (b) through (e) for each factor in the sequence that has associated rules; and
(g) calculating the order totals for the order using the values assigned to the factors of the sequence.

33. The method of claim 32 wherein in step (a) the order pricing sequence is selected by default according to the pricing model.

34. The method of claim 32 wherein in step (b) the rules are accessed from a data repository containing the pricing model data.

35. The method of claim 32 wherein in step (g) the order totals reflect one or a combination of a bundle discount, a group discount, and a volume discount.

36. The method of claim 32 wherein an additional step is required between steps (d) and (e) for conflict resolution in case of more than one candidate rule remaining after step (c).

37. The method of claim 25 wherein the conflict resolution step resolves rule conflicts according to a specified conflict resolution order specified in the factor being processed.

38. The method of claim 36 wherein the conflict resolution step resolves rule conflicts according to a specified resolution order specified in the factor being processed.
